(19) United States
(12) Patent Application Publication
(10) Pub. No.: US 2014/0068182 A1
(43) Pub. Date: Mar. 6, 2014

(54) Storage Virtualization In A Block-Level Storage System

(71) Applicant: DROBO, INC., San Jose, CA (US)

(72) Inventor: Julian Michael Terry, Los Gatos, CA (US)

(73) Assignee: DROBO, INC., San Jose, CA (US)

(21) Appl. No.: 13/777,107

(22) Filed: Feb. 26, 2013

Related U.S. Application Data
(60) Provisional application No. 61/696,535, filed on Sep. 4, 2012.

(51) Int. Cl. G06F 3/06

(52) U.S. Cl. CPC G06F 3/0614
USPC 711/114

(57) ABSTRACT

A data storage system that stores data has a logical address space divided into ordered areas and unordered areas. Retrieval of storage system metadata for a logical address is based on whether the address is located in an ordered area or an unordered area. Retrieval of metadata regarding addresses in ordered areas is performed using an arithmetic calculation, without accessing a block storage device. Retrieval of metadata regarding addresses in unordered areas is performed using lookup tables. In some embodiments, a mixture of ordered and unordered areas is determined to permit the data storage system to store its lookup tables entirely in volatile memory.

### CROSS-REFERENCE TO RELATED APPLICATION(S)

This patent application claims the benefit of U.S. Provisional Patent Application No. 61/696,535 filed on Sep. 4, 2012 (Attorney Docket No. 2950/122), which is hereby incorporated herein by reference in its entirety.

### TECHNICAL FIELD

Embodiments of the present invention relate to accessing and control of data storage in data processing systems that provide fault recovery by reconfiguration of storage space within one or more storage devices, and more particularly to improving data storage and retrieval speeds in such a data processing system having a virtualization layer that presents, to a host device, a unified address space for accessing and modifying data stored redundantly on the one or more storage devices.

### BACKGROUND ART

High-end data storage systems for computers and other devices may store data on multiple block storage devices, to provide the ability to recover stored data when one or more storage devices experience a fault or a failure. Data storage patterns, such as mirroring, striping with parity, and those using error-detecting and error-correcting codes, provide these systems with fault tolerance by storing multiple copies of data, or by storing additional data, that permit recovery if one or more storage devices fail. When a failure occurs, the design of these data storage patterns permits the data storage system to apply various mathematical operations to the data that are still readable to recover the initially-stored data. Further, the design of these systems often permits them to notify a system operator that a particular device has failed, and suggest that the failed device be replaced.

Data storage systems are designed according to various time and space constraints. For example, in a system with unlimited storage capacity, one might design the storage system to use a fast redundant data storage scheme, such as mirroring (e.g. RAID 1). However, in a system with severely limited storage capacity, one may be forced to use more space-saving storage patterns, such as striping with parity (e.g. RAID 4 or RAID 5). Some systems, such as the AutoRAID system from Hewlett Packard Company of Palo Alto, Calif., and BeyondRAID from Drobo, Inc. of San Jose, Calif. use a mixture of redundant storage patterns to provide a balance between these extremes.

In order to maintain a record of performance and usage characteristics, and data occupancy, prior art data storage systems maintain various lookup tables. Such lookup tables are modified when I/O instructions are received and processed. For example, a data storage system may include a lookup table that identifies whether a particular logical storage location has been accessed by its host device, and if so, whether data are currently stored there and in which redundancy area it resides. As another example, systems that store data according to a redundant data storage pattern must process read- and write-requests from a host device, such as a server computer, and translate them into corresponding read- and write-requests to implement redundancy. Such systems typically include a lookup table for each redundancy area that converts a single, logical storage address into a number of corresponding physical storage addresses.

As the amount of data that may be stored in data storage systems increases, the sizes of these lookup tables likewise increases, which can lead to serious problems. Cost constraints may limit the amount and type of hardware in the storage system, and the limited hardware may not be able to accommodate large lookup tables. For example, the amount of volatile memory, such as Random Access Memory (RAM), available in the storage system may be less than the size of the various lookup tables. In such situations, data from non-volatile memory (e.g., a hard disk drive) may need to be “swapped” into RAM before the lookup can be performed. However, as is known in the art, disk access is typically several orders of magnitude slower than RAM access. As these lookups must be performed for every data access, swapping drastically reduces storage system performance.

Various schemes are known to deal with this problem. In one design, a data storage system uses associative arrays, or hashes, to convert a lookup key into a value. Using hashes reduces the amount of storage required for the storage system to keep track of “sparse” data. However, the use of hashing requires additional computation for each table lookup (as compared to using flat tables), and this extra work decreases system response time and throughput. Also, as the storage system fills up, the benefit of using hashes to store data decreases, as the data become less sparse. Another scheme uses multiple, smaller tables at various levels of address granularity, where some of the tables fit into RAM and other (less frequently accessed) tables are stored on disk. This design requires several sub-lookups on the smaller tables, adding layers of indirection to the lookup process, and increasing overall memory usage. Further, when a table must be swapped back into RAM, storage system performance is reduced. While swapping occurs less frequently with such systems, it still occurs.

### SUMMARY OF THE EMBODIMENTS

Various embodiments of the invention enhance the performance and reduce the memory usage of data storage systems by dividing logical storage into ordered and unordered areas. Ordered areas in the storage system are those for which consecutive logical addresses received from the host are translated into consecutive physical addresses on the non-volatile storage devices, while unordered areas do not have this constraint. Metadata records that hold information about data located in ordered areas may be located by performing simple arithmetic, thereby obviating the need for a separate lookup table. Records that hold information about data located in unordered areas still require the use of lookup tables. However, by properly balancing the sizes of ordered and unordered areas, the overall size and number of such tables is reduced enough to permit all lookup tables to reside in faster, non-volatile memory. As a result, the data storage system does not suffer from slow performance due to swapping, and less expensive hardware may be used.

In a first embodiment of the invention there is provided a method of operating a data storage system having one or more block storage devices. The data storage system is capable of storing and retrieving data, in the block storage devices, on behalf of a host device, using a mixture of redundant data storage patterns. Each redundant data storage pattern operates on one or more of the block storage devices in the data storage system. The method begins by providing the data storage system with a host address space, wherein each block of data stored in the data storage system is associated with a host address in the host address space. The method continues with dividing the host address space into redundancy zones, whereby each host address that addresses stored data is uniquely associated with a redundancy zone, and each redundancy zone is configured to store data in the block storage devices according to a redundant data storage pattern determined for that zone. The address space of at least one redundancy zone is ordered, and the address space of at least one redundancy zone is unordered. The method next requires receiving, from the host device, a storage request associated with a host address in the host address space; determining a redundancy zone associated with the host address; and finally determining an offset for the received host address in the associated redundancy zone, as a function of whether the redundancy zone is configured to store only data having consecutive host addresses.

The method may be improved in various ways. For example, when the associated redundancy zone is configured to store only data having consecutive host addresses, determining the offset may consist of performing an arithmetic calculation in the data storage system. In particular, the arithmetic calculation may be performed without accessing a block storage device. By contrast, when the associated redundancy zone is configured not to store only data having consecutive host addresses, determining the offset may comprise searching a data structure that associates host addresses to offsets. In this case as well, the data structure may be searched without accessing a block storage device.

In a related embodiment, determining the redundancy zone associated with the received host address comprises allocating a redundancy zone, and associating the allocated redundancy zone with the received host address. In a further embodiment, the method is extended by servicing the storage request using a plurality of physical storage addresses that are determined as a function of both the offset and the redundant data storage pattern of the associated redundancy zone.

A system for executing these methods, and computer program products having computer program code for performing these methods, are also disclosed.

### BRIEF DESCRIPTION OF THE DRAWINGS

The foregoing features of embodiments will be more readily understood by reference to the following detailed description, taken with reference to the accompanying drawings, in which:

FIG. 1 is block schematic of a computing environment in accordance with an embodiment of the invention;

FIG. 2 is a flowchart showing a method by which a storage controller in accordance with an embodiment of the invention services an input/output request;

FIG. 3 shows how a cluster access table is used to access a data clusters in a zone, in accordance with an exemplary embodiment of the present invention; and

FIG. 4 is a flowchart showing how a cluster index table may be used in accordance with an embodiment of the invention.

### DETAILED DESCRIPTION OF SPECIFIC EMBODIMENTS

Various embodiments of the invention enhance the performance and reduce the memory usage of data storage systems by dividing logical storage into ordered and unordered areas. Ordered areas in the storage system are those for which consecutive logical addresses received from the host are translated into consecutive physical addresses on the non-volatile storage devices, while unordered areas do not have this constraint. Metadata records that hold information about data located in ordered areas may be located by performing simple arithmetic, thereby obviating the need for a separate lookup table. Records that hold information about data located in unordered areas still require the use of lookup tables. However, by properly balancing the sizes of ordered and unordered areas, the overall size and number of such tables is reduced enough to permit all lookup tables to reside in faster, non-volatile memory. As a result, the data storage system does not suffer from slow performance due to swapping, and less expensive hardware may be used.

As used in this description and the accompanying claims, the following terms shall have the meanings indicated, unless the context otherwise requires:

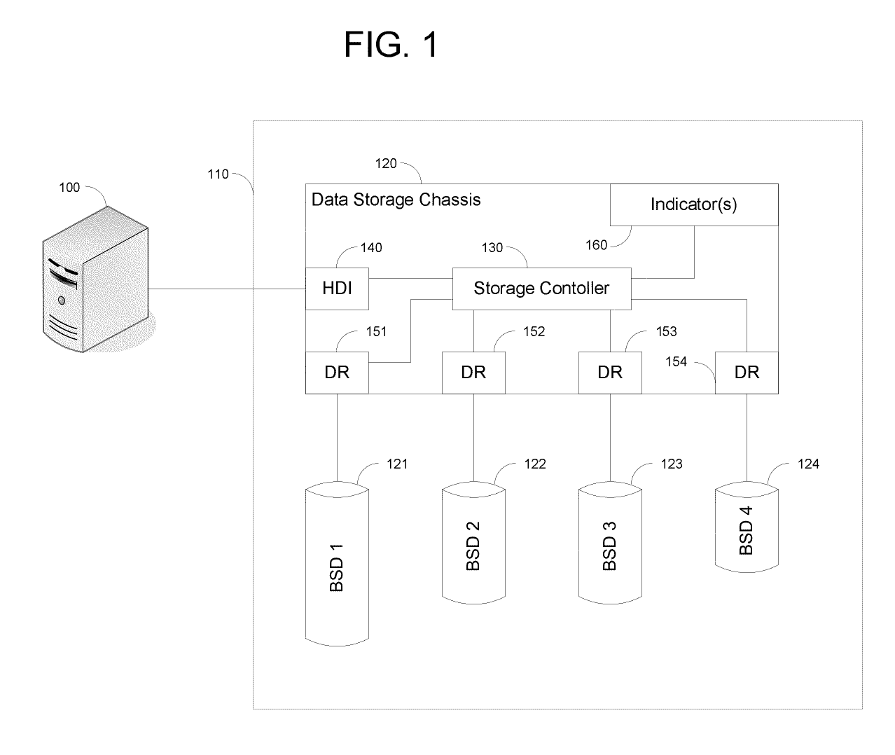

A “block” is a unit of data transfer and manipulation within a computing system, such as that shown schematically in FIG. 1. Forming data into blocks permits different components of the computing system to work together efficiently. Thus, while a computing system typically presents a user with a data interface based on the concept of files, a filesystem typically converts these files into blocks for storage throughout the system. Storage systems typically work with fixed-size blocks of data (e.g., a “block size” of 4 KB or 32 KB).

A “block storage device” (or “BSD”) is a non-volatile memory such as a hard disk drive (HDD) or solid state drive (SSD) that stores and retrieves fixed-sized blocks of data.

A “block-level storage system” (or “BLSS”) is a data storage system that contains one or more BSDs and a storage controller, outside the BSDs, that manages storage of blocks of data in the BSDs on behalf of a host device to which it is coupled.

A “sector” is a fixed-sized unit of data storage defined by the physical geometry of a block storage device. Each block storage device in a computing system may have a different sector size, although sectors typically are between 512 bytes and 4096 bytes.

A “redundant data storage pattern” is a layout scheme by which data are physically and redundantly distributed in one or more block storage devices. Such schemes include mirroring (e.g. RAID1), striping (e.g. RAID5), RAID6, dual parity, diagonal parity, low density parity check codes, turbo codes, and other similar redundancy schemes.

A “physical address” (also called “physical block address”, “PBA”, or “storage address”) is a number that indicates a location in the non-volatile memory of a block storage device where a particular block of data may be stored or found.

A “logical address” (also called “logical block address,” “LBA,” or “host address”) is a number that is used by a host device to address a block of data in a data storage system.

A “zone” is a storage construct that enables a data storage system to convert a logical address into one or more physical addresses. For example, in a BLSS that does not provide data storage redundancy, there is usually a one-to-one relationship between LBAs and PBAs, i.e., a particular LBA always maps to a corresponding PBA. However, in the data storage systems described herein, the mapping between an LBA and a PBA may change over time (e.g., the BLSS may move data from one storage location to another over time). Further, a single LBA may be associated with several PBAs, e.g., where the associations are defined by a redundant data storage pattern across one or more block storage devices. Such a BLSS shields these associations from the host device using the concept of zones, so that the BLSS appears to the host device to have a single, contiguous, logical address space, as if it were a single block storage device. This shielding effect is sometimes referred to as “storage virtualization”.

A “redundancy zone” in a data storage system is a storage zone that operates according to a particular redundant data storage pattern. A single data storage system may have several different redundant data storage patterns. In the typical embodiments disclosed herein, redundancy zones are configured to store the same, fixed amount of data (typically 1 gigabyte). For example, a redundancy zone configured for two-disk mirroring of one 1 GB of data typically consumes 2 GB of physical storage, while a redundancy zone configured for storing 1 GB of data according to three-disk striping typically consumes 1.5 GB of physical storage. One advantage of associating redundancy zones with the same, fixed amount of data is to facilitate migration between redundancy zones, e.g., to convert mirrored storage to striped storage and vice versa. Nevertheless, other embodiments may use differently sized redundancy zones in a single BLSS. A redundancy zone is composed of logical clusters and physical regions, both of which are defined below.

A “logical cluster” (or “cluster”) is the basic unit of logical data storage in a redundancy zone, and corresponds to a block having a logical block address. A typical cluster is associated with four kilobytes of data (i.e., the block size), although its size may differ in some embodiments.

A “physical region” (or “region”) is a unit of physical storage that is contiguously located in a single block storage device. A region participates collectively with other regions in the same data storage system (either on the same BSD or on other BSDs) to implement the redundant data storage pattern of its zone. The number of regions in a zone depends on the particular redundant data storage pattern. A region is composed of sectors and typically has a physical size equal to one-twenty-fourth of a gigabyte, although other region sizes may be used.

FIG. 1 is block schematic of a computing environment in accordance with an embodiment of the invention. Generally speaking, a computing system embodiment includes a host device 100 and a BLSS 110. The host device 100 may be any kind of computing device known in the art that requires data storage, for example a desktop computer, laptop computer, tablet computer, smartphone, or any other such device. In exemplary embodiments, the host device 100 runs a host filesystem that manages data storage at a file level but generates block-level storage requests to the BLSS 110, e.g., for storing and retrieving blocks of data.

In the exemplary embodiment shown in FIG. 1, BLSS 110 includes a data storage chassis 120 as well as provisions for a number of storage devices (e.g., slots in which block storage devices can be installed). Thus, at any given time, the BLSS 110 may have zero or more block storage devices installed. The exemplary BLSS 110 shown in FIG. 1 includes four block storage devices 121-124, labeled “BSD 1” through “BSD 4,” although in other embodiments more or fewer block storage devices may be present.

The data storage chassis 120 may be made of any material or combination of materials known in the art for use with electronic systems, such as molded plastic and metal. The data storage chassis 120 may have any of a number of form factors, and may be rack mountable. The data storage chassis 120 includes several functional components, including a storage controller 130 (which also may be referred to as the storage manager), a host device interface 140, block storage device receivers 151-154, and in some embodiments, one or more indicators 160.

The storage controller 130 controls the functions of the BLSS 110, including managing the storage of blocks of data in the block storage devices and processing storage requests received from the host filesystem running in the host device 100. In particular embodiments, the storage controller 130 implements redundant data storage using any of a variety of redundant data storage patterns, for example, as described in U.S. Pat. Nos. 7,814,272, 7,814,273, 7,818,531, 7,873,782 and U.S. Publication No. 2006/0174157, each of which is hereby incorporated herein by reference in its entirety. For example, the storage controller 130 may store some data received from the host device 100 mirrored across two block storage devices and may store other data received from the host device 100 striped across three or more storage devices. In this regard, the storage controller 130 determines PBAs for data to be stored in the block storage devices (or read from the block storage devices) and generates appropriate storage requests to the block storage devices. In the case of a read request received from the host device 100, the storage controller 130 returns data read from the block storage devices 121-124 to the host device 100, while in the case of a write request received from the host device 100, the data to be written is distributed amongst one or more of the block storage devices 121-124 according to a redundant data storage pattern selected for the data. Thus, the storage controller 130 manages physical storage of data within the BLSS 110 independently of the logical addressing scheme utilized by the host device 100. Also, the storage controller 130 controls the one or more indicators 160, if present, to indicate various conditions of the overall BLSS 110 and/or of individual block storage devices. Various methods for controlling the indicators are described in U.S. Pat. No. 7,818,531, issued Oct. 19, 2010, entitled “Storage System Condition Indicator and Method.” The storage controller 130 typically is implemented as a computer processor coupled to a non-volatile memory containing updateable firmware and a volatile memory for computation. However, any combination of hardware, software, and firmware may be used that satisfies the functional requirements described herein.

The host device 100 is coupled to the BLSS 110 through a host device interface 140. This host device interface may be, for example, a Thunderbolt interface, a USB port, a Firewire port, a serial or parallel port, or any other protocol (known or not yet known, including wireless) provided it can support a block addressing protocol. The block storage devices 121-124 are physically and electrically coupled to the BLSS 110 through respective device receivers 151-154. Such receivers may communicate with the storage controller 130 using any bus protocol known in the art for such purpose, including, but not limited to, IDE, SAS, SATA, or SCSI. While FIG. 1 shows block storage devices 121-124 external to the data storage chassis 120, in some embodiments the storage devices are received inside the chassis, and the (occupied) receivers 151-154 are covered by a panel to provide a pleasing overall chassis appearance. One such chassis is disclosed in U.S. Pat. No. 8,215,727, entitled “Carrierless Storage System Enclosure with Ejection Mechanism.”

The indicators 160 may be embodied in any of a number of ways, including as LEDs (either of a single color or multiple colors), LCDs (either alone or arranged to form a display), non-illuminated moving parts, or other such components. Individual indicators may be arranged to as to physically correspond to individual block storage devices. For example, a multi-color LED may be positioned near each device receiver 151-154, so that each color represents a suggestion whether to replace or upgrade the corresponding block storage device 121-124. Alternatively or in addition, a series of indicators may collectively indicate overall data occupancy. For example, ten LEDs may be positioned in a row, where each LED illuminates when another 10% of the available storage capacity (or fraction thereof) has been occupied by data. As described in more detail below, the storage controller 130 may use the indicators 160 to indicate conditions of the storage system not found in the prior art. Further, an indicator may be used to indicate whether the data storage chassis is receiving power, and other such indications known in the art.

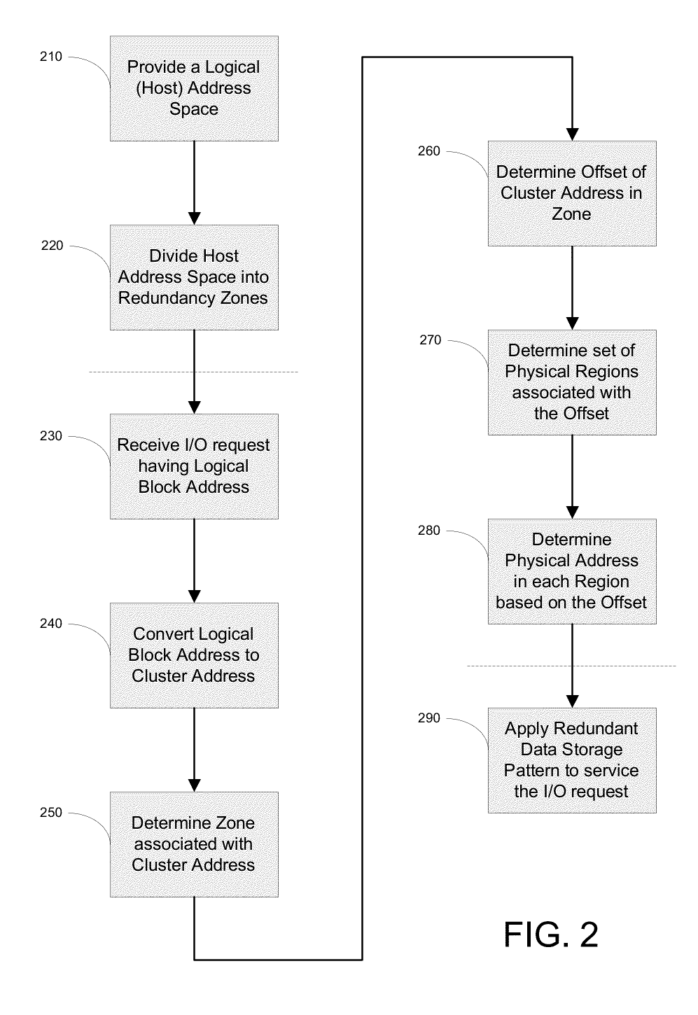

FIG. 2 is a flowchart showing a method by which a storage controller in accordance with an embodiment of the invention services an I/O request from a host device. Generally speaking, the method includes three phases, separated in the Figure using dashed lines: an initialization phase (processes 210-220), a translation phase (processes 230-280), and a servicing phase (process 290). In the initialization phase, the data storage system is prepared for storing data. After receiving a storage request from the host device, the data storage system translates any LBA found in the request into a set of physical addresses. These physical addresses are then accessed according to a particular redundancy scheme to service the storage request (i.e., to either read or write data). A description of one particular implementation of these processes may be found in U.S. Pat. No. 7,814,273, issued Oct. 12, 2010. Processes in accordance with embodiments of the present invention improve upon the processes found in the prior art, and are now explained in more detail.

In process 210, the data storage system is provided a logical (host) address space. Typically, this process occurs when the data storage system is first formatted by the host device. At this time, the host device prepares the data storage system to store data in the available logical storage space according to a particular filesystem format and according to a particular block size. The amount of logical storage space available within the data storage system may be a function of the filesystem chosen, the total storage space in the block storage devices, and the efficiency with which the block storage devices are used according to the redundant data storage patterns supported by the data storage system. In process 210, the available storage space is thus provided with a linear, logical address space for use by the host device, so that each block of data that is stored in the data storage system is associated with a host address. In one embodiment, in which block storage devices may be added or exchanged for larger storage devices as the data storage system fills up, the data storage system advertises to the host device an amount of logical storage space that is substantially larger than the actual available storage space. In this way, new block storage devices may be added to the data storage system, thereby increasing the amount of actual available storage space, without requiring the host device to reformat the data storage system or alter the logical address space.

The data storage system may simultaneously use several different redundant data storage patterns internally, e.g., to balance the responsiveness of storage operations against the amount of data stored at any given time. For example, a data storage system embodiment may first store data in a redundancy zone according to a fast pattern such as mirroring, and store later data in another redundancy zone according to a more compact pattern such as striping. Thus, in process 220, the data storage system divides the host address space into redundancy zones, where each redundancy zone is associated with a single redundant data storage pattern. This kind of hybrid system may convert zones from one storage pattern to another as it matures. For example, to reduce access latency, a data storage system may convert a zone having a more compressed, striped pattern to a mirrored pattern using a new block storage device when the new device is added. Each block of data that is stored in the data storage system is uniquely associated with a redundancy zone, and each redundancy zone is configured to store data in the block storage devices according to its redundant data storage pattern.

Some time after the data storage system has been initialized, in process 230 the data storage system receives from the host device a storage request that is associated with a host address. As is known in the art, the storage request refers at least to a block of data according to a block size defined by a filesystem, and an instruction to either retrieve (read) the data or store (write) it in the data storage system. Once the storage request is received, the data storage system must translate the host address (LBA) into one or more physical addresses with which its data are associated.

The translation phase begins with process 240, in which the data storage system converts the LBA to a cluster address. This process may be necessary in some embodiments for which the filesystem block size differs from the cluster size in the data storage system. If required, this process typically consists of a multiplication or a division (with remainder) performed by a storage controller in the data storage system. Optionally, the cluster address may be further subdivided to determine a requested logical sector address.

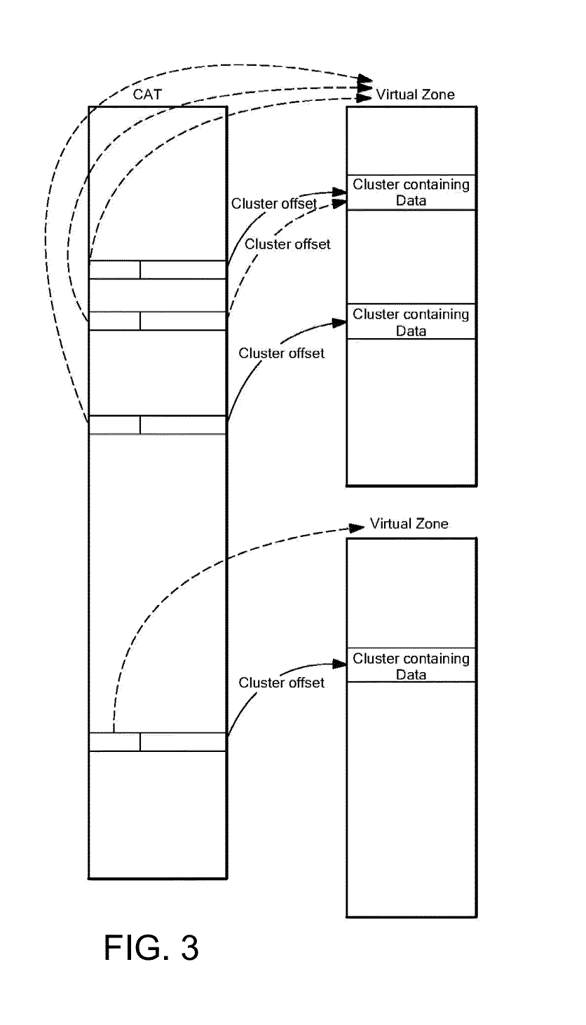

The translation phase continues with process 250, in which the system determines a redundancy zone associated with the cluster address. In a related process 260, the storage system determines an offset of the cluster address within its redundancy zone. Typically, these processes include locating the cluster address in a cluster access table (“CAT”), such as the one shown in FIG. 3. A CAT includes one record for each cluster address, and each record is associated with the information sought by the processes 250, 260. Various embodiments of the present invention improve on these processes, and are described in more detail below in connection with cluster groups.

Each redundancy zone uses multiple regions to provide fault tolerance, and therefore the determined cluster offset corresponds to a number of physical offsets, each within a different physical storage region. Thus, in the next process 270, the storage system determines the set of physical regions associated with the cluster offset. Because a zone may contain several regions that are not contiguously located on a storage device, a lookup table (“Zone table”) is ordinarily used to determine which physical regions correspond to a given logical offset within a zone. Various embodiments of the invention improve upon this situation, and are described below in connection with ordered zones.

In process 280, the data storage system determines a physical address in each region based on the logical offset. The offset of the cluster address within a given region may be determined from its offset in the zone by performing an arithmetic calculation (e.g., dividing the zone size by the region size and retaining the remainder). This offset is then added to the starting physical address of each region in its respective block storage device, to yield a final set of physical sectors on the various block storage devices that correspond to the given cluster address.

In process 290, the data storage system applies the redundant data storage pattern of the zone (determined in process 250) to the sectors at the physical addresses (determined in process 280) to service the I/O request (received in process 230). Servicing a write request requires dividing the block of data into data sectors and optionally computing parity sectors, then storing them at the physical addresses previously determined. Servicing a read request includes combining the various data and parity sectors into a block of data for a read request, checking any parity sectors to ensure that the data are correct according to methods known in the art for doing so. For a write request, the storage system returns an indication of success or failure to the host device. For a read request, the storage system returns the block of data (or an error indication) to the host device.

In the prior art, a given redundancy zone is configured to store data having any LBA in the host address space. This configuration is very space-efficient in typical applications using such storage systems, because it avoids creating large spans of logical address space that are empty (as is common for sparse filesystems and storage systems that have not yet stored much data).

However, a space-efficient storage configuration may be time-inefficient. In particular, a redundancy zone storing data having any LBA typically requires a lookup in the CAT to determine which zone contains the LBA of any given request. The CAT must be traversed each time an LBA is encountered. In a 2 terabyte (TB) address space having 4 KB clusters, there are 536,870,912 entries in the CAT. The CAT itself may require a great deal of space to store. It may not be possible to store the CAT entirely in volatile memory due to manufacturing or cost constraints. A cache may be used for this purpose, but a cache miss requires a portion of the CAT to be fetched from non-volatile memory (i.e., disk). This process of swapping portions of the CAT between non-volatile and volatile memory slows down the lookup process. In the worst case, a single I/O transaction may require two (slow) data storage accesses: a first access to locate the correct zone for the LBA in the CAT, and a second access to fetch the data from the block storage devices to service the request. This case is very time-inefficient, as it may effectively double data access times.

Various embodiments of the present invention provide solutions to the problems of time inefficiency and overly large CAT tables that do not fit in the volatile memory of the data storage system. In a first improved embodiment, some clusters within the logical address space are organized into groups that are in consecutive LBA order. Such groups are called “cluster groups” or “CGroups.” In this embodiment, each CAT record refers to a CGroup instead of only single clusters. This CAT advantageously is backwards compatible with prior art storage systems, as each CAT record may indicate that its cluster group has a size of one cluster. However, the use of CGroups instead of clusters in the CAT reduces the number of entries required to be stored in the CAT, thereby making the CAT itself more space-efficient than address lookup tables. According to the first improved embodiment, the data storage system must map a cluster address onto a CGroup before looking up the CGroup in the CAT. One particularly simple way to do this is to alter the process 240 to convert an LBA into a CGroup, rather than a cluster address. An alternate mechanism is discussed below in connection with a cluster index table.

In one embodiment using cluster groups, each CGroup contains a number of clusters that is a power of two, e.g., 1, 2, or 4 clusters (or more). In this embodiment, a zone divides its entire logical address space into units of CGroups, rather than individual clusters. In this way, a granularity of the zone is made more coarse. Different zones may define differently sized CGroups, and data in a zone formatted with a large CGroup may be accessed using a CGroup size that is smaller.

In a second improved embodiment, each given redundancy zone uses a configuration in which it stores only data having consecutive host addresses. Such zones are called “ordered zones,” in contrast to “unordered zones” that are not so configured. Ordered zones are less space-efficient than unordered zones in some applications. However, they are much more time-efficient, as an LBA lookup may be performed using a simple calculation rather than an expensive table lookup. In particular, once it has been determined that a given cluster address lies in an ordered zone, its actual offset within that zone may be determined, e.g., by simply subtracting the starting logical address of the ordered zone from the cluster address.

The second improvement advantageously avoids the need to consult a CAT at all for ordered zones. In systems that cannot accommodate in memory a CAT having hundreds of millions of entries, this second improvement may shrink the CAT enough to entirely fit in memory, thereby substantially reducing storage request latency. Moreover, this improvement may be employed in a hybrid data storage system, in which redundancy zones are divided between the two configurations.

The first and second improvements may be combined; that is to say, an ordered zone may access its logical address space using CGroups instead of individual clusters. In an embodiment combining these improvements, the size of the CAT is reduced for unordered zones, and its use is entirely eliminated with respect to ordered zones. This combination advantageously increases the responsiveness of the data storage system, especially for read requests, while simultaneously decreasing its internal memory usage.

One key advantage of combining these improvements is the synergistic use of ordered ranges and ordered zones. Typically, file systems do not randomly allocate files across the disk, but store files and groups of files together. This means that if one LBA is written to, the chances are that the following LBAs also will be written to (if not now, then with a higher probability of being accessed later). When an ordered range is used, an entire zone is allocated to a given LBA range, that range being related to the LBA of the write that caused to zone to be allocated.

In a third improvement, zones may be combined to form “zone groups,” or ZGroups. A ZGroup normally is formed from several ordered zones whose address spaces are contiguous, thereby forming a “super ordered zone.” A ZGroup may also be formed from several unordered zones to form a “super unordered zone.” The use of ZGroups does not shrink the number of records in a CAT, but it advantageously reduces the size of these records, as described below. A super ordered zone is used to improve both time and space efficiencies: it combines the speed of fast offset calculation with a savings in the size of each CAT record. A super unordered zone realizes at least the space savings of the smaller CAT records.

In a fourth improvement, the above ideas may be extended to produce a “fully ordered volume.” A fully ordered volume is a configuration where an entire volume is stored in ordered zones or ordered ZGroups. Assuming a 16 TB volume, 1 GB zones, and a 32 byte CAT entry, the CAT will be 32×16×1024 bytes in size=512 k bytes if every gigabyte of storage has been written to. It is generally possible to cache this much data, or at least very large portions of it, in a single CPU cache (for example, the L2 cache). Of course, most of the time the CAT can be much smaller, especially if zone groups are used.

To enable these improvements, a mechanism is now described to distinguish between clusters that require a CAT lookup and those that do not. Embodiments using these improvements have a cluster index table (“CIT”) that adds a level of indirection to the lookup process. A CIT contains a number of records, each defining (for example) an LBA range, a CGroup size, a flag that indicates whether the corresponding zone is ordered or not, and a reference (e.g., a pointer) to one of an ordered zone; an ordered ZGroup; a CAT record for an unordered zone; an unordered ZGroup containing the LBA range; or the reference may be (or point to) a null datum if that LBA range is not associated with a zone or ZGroup.

When a read occurs, the CIT is accessed and if the LBA range falls within an ordered range, the offset of the LBA within the zone can be calculated without reading any CAT entries. The synergistic effect is thus especially pronounced for read requests: using this improvement, consecutive blocks of a file are almost always stored in the same zone, permitting the read-ahead algorithm to be employed; by contrast, under the configuration found in the prior art, consecutive blocks of a file may be stored in different zones entirely, thereby nullifying the advantages of this algorithm.

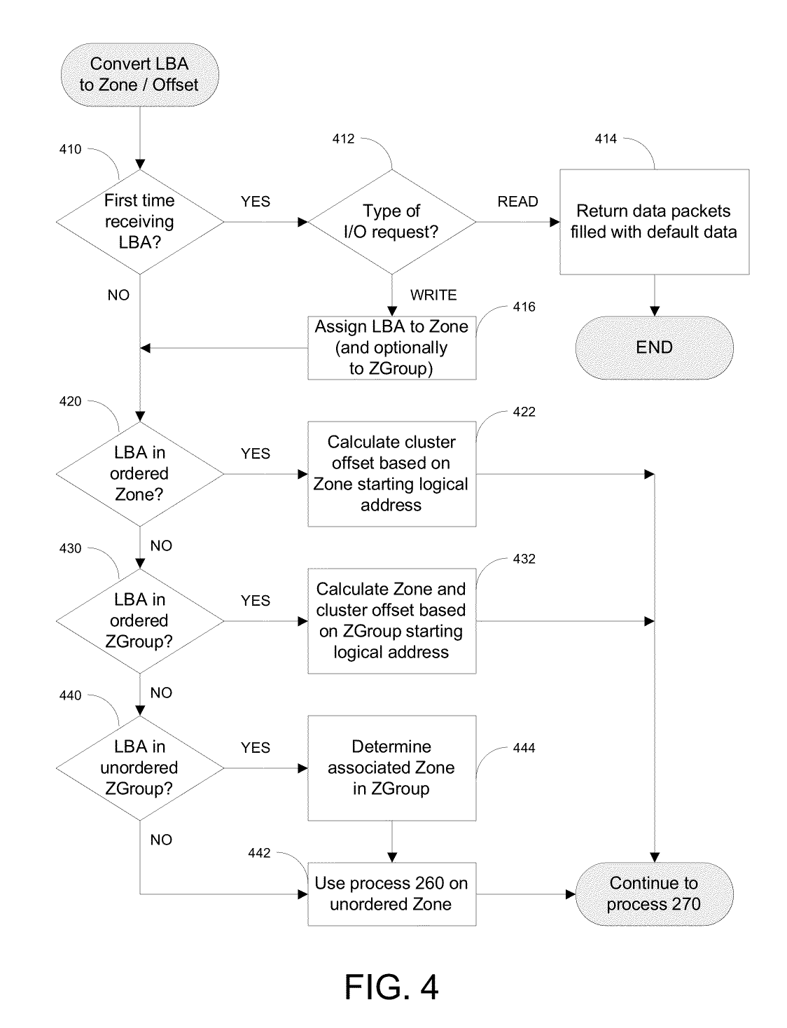

A CIT may supplement processes 240-260 to convert an LBA to a zone and an offset, as shown in FIG. 4 and now described. The method begins in process 410, where the data storage system determines whether an LBA (for example, one received in process 230) has been previously received. For example, the reference in a CIT record associated with the LBA may be checked to determine whether it is null. If this is the first time the data storage system has encountered this particular LBA, then the method proceeds to process 412, in which the data storage system determines the type of I/O request. If the request is to read data, then the result of the request must be undefined, so in process 414 the data storage system returns data packets filled with default data (e.g., all zeroes), and the method then terminates. If the request is to write data, then in process 416 the data storage system assigns the LBA to a zone (and optionally a ZGroup). This process 416 is trivial if the received LBA is contained in an LBA range that is already assigned to an ordered zone (or ZGroup). If the LBA is not within the span of an existing ordered zone (or ZGroup), then it may be assigned to an unordered zone, an unordered ZGroup, or to a newly-allocated ordered zone. The LBA assignment is determined, for example, according to one or a combination of the current data storage capacity and occupation of the block storage devices (either individually, collectively, or both); the usage characteristics of the data storage system by the host device; a manual setting made by a user of the host device; a factory default setting; or the type of data being stored (e.g. transactional data or bulk data). To assign an LBA to an unordered zone or ZGroup, a CAT entry is created or updated. To assign an LBA to a new ordered zone, the zone must be allocated and initialized with a logical address space that contains the received LBA and a collection of physical regions, which themselves may need to be allocated. At this time, the new zone is also assigned a CGroup size so that its logical address space may be properly formatted.

The method continues in process 420, in which the data storage system determines whether the received LBA lays within an ordered zone. This may be easily done, for example, by consulting a flag or flags in the CIT record that relate to the received LBA. In one embodiment, the LBA is considered part of an LBA range defined by a starting address and an ending address that are typically determined by selecting one or more high bits from a binary representation of the LBA (e.g., by applying a bit mask). In this case, the CIT record may be associated with the LBA range instead of the LBA, and the received LBA is first masked to determine the proper CIT record. In either case, if the LBA is within the span of an ordered zone, in process 422 the system calculates the offset in the ordered zone of the first cluster associated with the LBA by an arithmetic calculation based on a zone starting logical address. In particular, the zone starting logical address is subtracted from the logical block address to yield the offset: LBA−Zone_start=offset. Once the zone and offset are known, the use of the CIT ends and the overall translation phase of FIG. 2 continues in process 270, as indicated. Note that this calculation may be performed without accessing the block storage devices themselves (or indeed, any non-volatile memory).

If the LBA does not lay within an ordered zone, the method continues in process 430, in which the data storage system determines whether the received LBA lays within an ordered ZGroup. As before, if the CIT records pertain to LBA ranges, the LBA is first masked to determine its LBA range. If the LBA lays within an ordered ZGroup, then in process 432 the system calculates both the particular zone in the ZGroup, and the cluster offset in that zone. These numbers may be determined by the following formula: LBA−ZGroup_start=zone*sizeof(Zone)+offset, where LBA is the logical block address, ZGroup_start is the starting address of the relevant ZGroup, and the size of a zone's logical address space is 1 GB in the exemplary embodiments disclosed herein. This equation may be solved for “zone” and “offset” using an integer division of the number (LBA−ZGroup_start) by the size of a zone, whereby the (zero-indexed) zone number within the ZGroup is the quotient and the cluster offset in that zone is the remainder. Modem CPUs typically have a primitive instruction that calculates both a quotient and a remainder at once and stores them in CPU register memory, and such a primitive instruction may be used in various embodiments to make the process 432 very efficient, especially if the list of ordered ZGroups is stored in volatile memory. As before, the zone and offset are now both known, and the translation phase of FIG. 2 may continue to process 270.

If the LBA does not lay within an ordered zone or an ordered ZGroup, then the method of FIG. 4 continues to process 440, in which the data storage system determines whether the received LBA lays within an unordered ZGroup. If the LBA does not lay in an unordered ZGroup, then it must lay in an unordered zone in this described embodiment. In this case, in process 442, the data storage system reverts to using a CAT record to determine the cluster offset, as in process 260 described above, and continues with process 270 as shown. However, if the LBA does lay in an unordered ZGroup, then in process 444 the data storage system must first determine the zone in the ZGroup that is associated with the LBA. This process may be implemented by storing a CAT for each ZGroup, and augmenting the CAT to including information relating to the distribution of LBAs within the ZGroup. Alternately, a separate table may be used for this purpose. Once the associated zone is determined, in process 442 the CAT associated with the unordered zone is searched as in process 260.

As may be appreciated by one having ordinary skill in the art, the outcomes determined in the processes 420, 430, 440 are mutually exclusive and the determinations have no side effects. Thus these processes may be performed in any order. The ordering of these processes in FIG. 4 is merely exemplary, and all other orderings of these processes are considered to be within the scope of the disclosure.

Generally speaking, the slowdown caused by the use of another layer of abstraction (ie., the CIT) is more than outweighed by the speed up provided by the use of ordered zones. Further, the space used by the CIT is typically more than outweighed by the space savings realized in the CAT from the use of CGroups and ZGroups. In particular, use of these improvements may enable a data storage system to shrink the CAT enough to store both the CAT and the CIT in volatile memory, thereby entirely eliminating the problem of swapping portions of the CAT to and from the block storage devices. Moreover, the increase in speed may bring data storage system performance on par (or nearly on par) with that of hardware RAID systems, even if these improvements are implemented in software.

To maintain the increase in speed for write requests pertaining to new LBAs (as described above in connection with process 416), when allocating a new zone, the new zone is preferably formatted as an ordered zone. Doing so avoids the necessity of looking up the LBA in a CAT during subsequent I/O requests (remembering that the lookup may require detrimental swapping of the CAT from block storage to volatile memory). In this particular embodiment, the data storage system may allocate, then not use, a great deal of storage space. In this case, a background process may be run periodically or manually inside the data storage system to convert ordered zones into unordered zones by creating CAT tables based on the occupation of data in each zone.

Further, some embodiments of the data storage system include indicator lights for indicating overall storage usage as a function of data occupation. In these embodiments, allocated but unused storage space should not count toward the indicated occupation (as that space is not, in fact, occupied by data). Further, control of the indicator lights may be modified to provide more information than simply data occupation. For example, the indicator lights may indicate a relative proportion of ordered storage capacity to unordered storage capacity.

A CIT range that points to an unordered ZGroup allows the use of a smaller CAT table entry, as now described. In a normal CAT entry, the pointer to the cluster or CGroup consists of a zone number and an offset into that zone. The zone entry must be large enough that any zone in the block storage devices can be referenced by the CAT entry. This means that the size of a CAT table is strongly linked to the maximum size of the disk pack. If the maximum size of available storage changes, the CAT tables need to be re-written if an older pack is placed in a newer system.

However, an unordered ZGroup allows the CAT Table for that ZGroup to be customized to that ZGroup, requiring only a small CAT rewrite in the event that the number of zones in the ZGroup grows over a predefined limit. The CAT entry for the ZGroup does not need to contain a zone number, as the link to the ZGroup would be made in the CIT rather than the CAT. The size of the offset would depend on the CGroup size and the maximum number of zones allocated to the ZGroup. Only LBAs within the CIT entry range would be stored in the ZGroup. The benefit of using unordered ZGroups in this way depends on the ratios between the ZGroup size, the maximum disk pack size, and the volume (i.e., filesystem) size. The data storage system may calculate these ratios to make a decision as to whether there is a useful trade off to make in this regard.

Embodiments of the invention described above pertain generally to reducing the latency and storage requirements of converting a logical address, such as an LBA, into an offset in a zone. However, a data storage system typically converts such a logical offset into a plurality of regions and physical offsets using one or more lookup tables (“zone tables”). These zone tables also may be large and cumbersome to traverse. Thus, in accordance with further embodiments of the invention, the ideas set forth above also may be advantageously applied to zone tables instead of, or in addition to, cluster access tables.

For example, a data storage system having 2 TB of combined block storage may have up to 2048 zone table entries pointing to up to 24 regions each. As block storage devices became much larger, however, it became advantageous to increase the size of zones. Increasing the size of zones reduces the number of zone table entries relative to the size of the disk pack.

In one embodiment, this is accomplished using region groups (“RGroups”). An RGroup is the physical analog of the virtual CGroup. An RGroup is a group of regions in contiguous order on the disk that are used as if they were a single large region. As with the size of CGroups, the number of regions that form an RGroup may be a power of two. As with the CAT and CGroups, in this embodiment, zone tables are modified to point to RGroups instead of regions. As the RGroups are contiguous on disk, the region numbers held in the zone table act as the base number for each RGroup used. The size of the RGroup used by a specific zone may be stored in the zone table. Any given zone would use one size of RGroup, but different zones could use different sizes of RGroup.

The initial zone size may be based on the size of the initial block storage capacity; for example one quarter of one percent of the total storage available. RGroups having more than one region would be used only if the particular disk pack are enough contiguous regions available in the disk pack. Re-layout from one zone group to another is possible, allowing the entire disk pack space to be used. Typically, the format on disk of a zone based on RGroups looks exactly like a disk laid out using standard zones and regions. This allows rapid decomposition of the larger zones into smaller zones, if necessary. Thus, a 2 GB zone can be converted into two 1 GB zones simply by adjusting the zone table (and the CAT if the zone is unordered).

The above improvements may be employed in numerous ways. For example, in one embodiment, the decision whether to make a zone ordered or unordered may be based on the type of data being stored therein (as indicated by the host device or as inferred by the storage controller in the data storage system, e.g., as discussed in more detail below). For example, database files and other such files whose contents are randomly accessed (e.g. filesystem allocation tables), and small files that are often created and destroyed (e.g. lock files), may be stored by the host device using scattered logical host addresses. These types of “transactional” files may be advantageously stored using a CAT. By contrast, rarely accessed files and files that are often appended to (e.g. log files) are typically stored using blocks of sequential host addresses. These files may be advantageously stored using ordered zones instead of a CAT.

In another embodiment, a background task may convert ordered zones to be unordered, and vice versa. For example, ordered zones tend to have large allocated, but unused space. If too many such zones are present and the fraction of allocated storage is approaching the overall block storage capacity, according to a determination made by the data storage system, the background task converts one or more ordered zones to be unordered by creating CAT tables for these zones, thereby making the unused space directly available for storage. This conversion favors space over time. Conversely, a large data file that is sequentially accessed may be stored in a number of unordered zones, when read and write performance of the data storage system would be improved by storing the file in one or more ordered zones. In such a situation, the background task converts one or more of the unordered zones into ordered zones. In such a situation, some data in the CAT for the unordered zone is typically moved to another zone, and the logical address space of the zone defragmented by the system before the CAT for that zone is deleted. This conversion favors time (speed) over space.

Other embodiments may take advantage of information obtained by the data storage system about the filesystem format. Such information is not typically communicated by the host device to the data storage system but rather may be inferred, for example, based on interactions between the host filesystem and the data storage system or by “mining” information from host filesystem data structures, e.g., as described in U.S. Pat. No. 7,873,782, issued Jan. 18, 2011, entitled “Filesystem-Aware Block Storage System, Apparatus, and Method.” In one such embodiment, the CGroup size may be set equal to the cluster size of the underlying filesystem. For example, a 2 TB volume formatted as FAT32 uses 32 KB host clusters. If the data storage system uses 4 KB clusters internally, selecting a CGroup size of 8 clusters advantageously would permit the host device and the data storage system to use the same sized logical storage unit (i.e., 32 KB host cluster and 32 KB CGroup). Such a data storage system may include multiple volumes having different host cluster sizes. If so, the system may format the zones comprising the different volumes according to different CGroup sizes to provide this feature.

One may also use filesystem information to identify filesystem areas containing metadata or small files, and associate them with an ordered zone having a small CGroup size. For example, in clustered filesystems such as VMFS, bitmaps are accessed on a read-modify-write basis that makes accessing them quite inefficient in the prior art. Removing the CAT lookup improves performance greatly. Similarly, NTFS reserves certain areas of the disk for “small files,” which may be stored in a zone with an appropriately sized CGroup.

In further embodiments, the data storage system analyzes transaction size and frequency. Doing so makes it possible to store data in a zone that has storage credentials suitable for the transaction type. Transaction sizes themselves are most efficiently stored in zones that have an identical CGroup Size. Data ranges that are frequently accessed are most effectively stored in ordered zones where fewer lookups are required.

It should be noted that embodiments of the present invention are not limited to any particular types of devices. For example, host device 100 may be a host computer that runs a host filesystem, and BLSS 110 may be an intelligent storage array of the types sold by Drobo, Inc. of Santa Clara, Calif. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The embodiments of the invention described above are intended to be merely exemplary; numerous variations and modifications will be apparent to those skilled in the art. All such variations and modifications are intended to be within the scope of the present invention as defined in any appended claims. The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be distributed as a product comprising a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. Claims directed to cluster groups (and CGroups in combination with ordered/unordered zones; “impedance matching” CGroup size against filesystem size)

P2. Claims directed to zone groups (and ZGroups in combination with ordered/unordered zones)

P3. Claims directed to region groups (and RGroups in combination with ordered/unordered zones; use of RGroups with zone tables)

P4. Claims directed to fully ordered volumes (and when they should and should not be used)

P5. Claims directed to indicator lights with improved virtualization

P6. Claims directed to determining whether to make zones ordered or unordered (e.g., usage-based tiering; transactional vs. bulk; filesystem-aware decisions)

P7. Claims directed to mechanisms for converting ordered zones to unordered zones and vice versa

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A method of operating a data storage system having one or more block storage devices, the data storage system being capable of storing and retrieving data, in the block storage devices, on behalf of a host device, using a mixture of redundant data storage patterns, each redundant data storage pattern operating on one or more of the block storage devices in the data storage system, the method comprising:
providing the data storage system with a host address space, wherein each block of data stored in the data storage system is associated with a host address in the host address space;
dividing the host address space into redundancy zones, whereby each host address that addresses stored data is uniquely associated with a redundancy zone, each redundancy zone being configured to store data in the block storage devices according to a redundant data storage pattern determined for that zone, the address space of at least one redundancy zone being ordered and the address space of at least one redundancy zone being unordered;
receiving, from the host device, a storage request associated with a host address in the host address space;
determining a redundancy zone associated with the host address; and
determining an offset for the received host address in the associated redundancy zone, as a function of whether the redundancy zone is configured to store only data having consecutive host addresses.

2. A method according to claim 1, wherein when the associated redundancy zone is configured to store only data having consecutive host addresses, determining the offset consists of performing an arithmetic calculation in the data storage system.

3. A method according to claim 2, wherein the arithmetic calculation is performed without accessing a block storage device.

4. A method according to claim 1, wherein when the associated redundancy zone is configured not to store only data having consecutive host addresses, determining the offset comprises searching a data structure that associates host addresses to offsets.

5. A method according to claim 4, wherein the data structure is searched without accessing a block storage device.

6. A method according to claim 1, wherein determining the redundancy zone associated with the received host address comprises:
allocating a redundancy zone; and
associating the allocated redundancy zone with the received host address.

7. A method according to claim 1, further comprising:
servicing the storage request using a plurality of physical storage addresses that are determined as a function of both the offset and the redundant data storage pattern of the associated redundancy zone.

8. A data storage system comprising:
a plurality of block storage device receivers, each block storage device receiver capable of receiving a block storage device; and
a storage controller coupled to the plurality of block storage device receivers, the storage controller configured to:
(i) provide the data storage system with a host address space as a function of the total storage capacity of one or more received block storage devices, wherein each block of data stored in the data storage system is associated with a host address in the host address space,
(ii) divide the host address space into redundancy zones, whereby each host address that addresses stored data is uniquely associated with a redundancy zone, each redundancy zone being configured to store data in the received block storage devices according to a redundant data storage pattern determined for that zone, the address space of at least one redundancy zone being ordered and the address space of at least one redundancy zone being unordered,
(iii) receive, from a host device, a storage request associated with a host address in the host address space,
(iv) determine a redundancy zone associated with the host address, and
(v) determine an offset for the received host address in the associated redundancy zone, as a function of whether the redundancy zone is configured to store only data having consecutive host addresses.

9. A system according to claim 8, wherein when the associated redundancy zone is configured to store only data having consecutive host addresses, determining the offset consists of performing an arithmetic calculation by the storage controller.

10. A system according to claim 9, wherein the arithmetic calculation is performed without accessing a block storage device.

11. A system according to claim 8, wherein when the associated redundancy zone is configured not to store only data having consecutive host addresses, determining the offset comprises searching a data structure that associates host addresses to offsets.

12. A system according to claim 11, wherein the data structure is searched without accessing a block storage device.

13. A system according to claim 8, wherein determining the redundancy zone associated with the received host address comprises:
allocating a redundancy zone; and
associating the allocated redundancy zone with the received host address.

14. A system according to claim 8, wherein the storage controller is further configured to:
service the storage request using a plurality of physical storage addresses that are determined as a function of both the offset and the redundant data storage pattern of the associated redundancy zone.

15. A computer program product for operating a data storage system having one or more block storage devices, the data storage system being capable of storing and retrieving data, in the block storage devices, on behalf of a host device, using a mixture of redundant data storage patterns, each redundant data storage pattern operating on one or more of the block storage devices in the data storage system, the computer program product comprising a non-transitory, computer-usable medium in which is stored computer program code comprising:
program code for providing the data storage system with a host address space, wherein each block of data stored in the data storage system is associated with a host address in the host address space;
program code for dividing the host address space into redundancy zones, whereby each host address that addresses stored data is uniquely associated with a redundancy zone, each redundancy zone being configured to store data in the block storage devices according to a redundant data storage pattern determined for that zone, the address space of at least one redundancy zone being ordered and the address space of at least one redundancy zone being unordered;
program code for receiving, from the host device, a storage request associated with a host address in the host address space;
program code for determining a redundancy zone associated with the host address; and
program code for determining an offset for the received host address in the associated redundancy zone, as a function of whether the redundancy zone is configured to store only data having consecutive host addresses.

16. A computer program product according to claim 15, wherein when the associated redundancy zone is configured to store only data having consecutive host addresses, determining the offset consists of performing an arithmetic calculation in the data storage system.

17. A computer program product according to claim 16, wherein the arithmetic calculation is performed without accessing a block storage device.

18. A computer program product according to claim 15, wherein when the associated redundancy zone is configured not to store only data having consecutive host addresses, determining the offset comprises searching a data structure that associates host addresses to offsets.

19. A computer program product according to claim 18, wherein the data structure is searched without accessing a block storage device.

20. A computer program product according to claim 15, wherein determining the redundancy zone associated with the received host address comprises:
allocating a redundancy zone; and
associating the allocated redundancy zone with the received host address.

21. A computer program product according to claim 15, further comprising:
program code for servicing the storage request using a plurality of physical storage addresses that are determined as a function of both the offset and the redundant data storage pattern of the associated redundancy zone.
